(19) United States
(12) Patent Application Publication
(10) Pub. No.: US 2015/0070923 A1
(43) Pub. Date: Mar. 12, 2015

(54) VEHICULAR LAMP

(71) Applicant: KOITO MANUFACTURING CO., LTD., Tokyo (JP)

(72) Inventor: Takahiro KADOWAKI, Shizuoka-shi (JP)

(73) Assignee: KOITO MANUFACTURING CO., LTD., Tokyo (JP)

(21) Appl. No.: 14/478,173

(22) Filed: Sep. 5, 2014

(30) Foreign Application Priority Data
Sep. 10, 2013 (JP) 2013-187577

(51) Int. Cl. F21S 8/10

(52) U.S. Cl. CPC F21S 48/1109; F21S 48/115; F21S 48/1388; F21Y 2101/02
USPC 362/517

(57) ABSTRACT

A vehicular lamp includes: a circuit board having three or more light source mounting portions provided along a vehicle-width direction; a plurality of light sources mounted on the respective light source mounting portions; and a reflector unit having three or more reflectors each reflecting light from each of the light sources. The reflector unit has a first positioning pin and a second positioning pin. The circuit board has a first positioning hole to receive the first positioning pin and a second positioning hole to receive the second positioning pin. The first positioning hole is provided at a location inward of a first end light source mounting portion positioned on one end side in the vehicle-width direction, and the second positioning hole is provided at a position inward of a second end light source mounting portion positioned on the other end side in the vehicle-width direction.

### INCORPORATION BY REFERENCE

The disclosure of Japanese Patent Application No. 2013-187557 filed on Sep. 10, 2013 including the specification, drawings and abstract is incorporated herein by reference in its entirety.

### BACKGROUND OF THE INVENTION

1. Field of the Invention

The invention relates to a vehicular lamp.

2. Description of Related Art

Conventionally, vehicular lamps having a plurality of light-emitting diodes (LEDs) and a plurality of reflectors each reflecting light from each of the LEDs have been available (see, for example, Japanese Patent Application Publication No. 2011-81975 (JP2011-81975 A)).

However, it is likely that the vehicular lamps having the plurality of LEDs and the plurality of reflectors are upsized.

### SUMMARY OF THE INVENTION

The invention provides a vehicular lamp that is small in size although it has a plurality of light sources and reflectors.

An aspect of the invention relates to a vehicular lamp including: a circuit board having three or more light source mounting portions provided along a vehicle-width direction; a plurality of light sources mounted on the respective light source mounting portions; and a reflector unit having three or more reflectors each reflecting light from each of the light sources. The reflector unit has a first positioning pin and a second positioning pin. The circuit board has a first positioning hole to receive the first positioning pin and a second positioning hole to receive the second positioning pin. The first positioning hole is provided at a location inward of a first end light source mounting portion positioned on one end side of the circuit board in the vehicle-width direction, among the light source mounting portions, and the second positioning hole is provided at a position inward of a second end light source mounting portion positioned on the other end side of the circuit board in the vehicle-width direction, among the light source mounting portion.

The first positioning hole may be provided between the first end light source mounting portion and one of the light source mounting portions adjacent to the first end light source mounting portion, and the second positioning hole may be provided between the second end light source mounting portion and one of the light source mounting portions adjacent to the second light source mounting portion.

The first positioning hole may be f a long hole extending in the vehicle-width direction of the circuit board, and the second positioning hole may be a substantially same shape and size as the second positioning pin.

According to an embodiment of the invention, it is possible to achieve a vehicular lamp that is small in size although it has a plurality of light sources and reflectors.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic horizontal cross-sectional view of a vehicular lamp according to an embodiment of the invention;

FIG. 2 is a cross-sectional view of the vehicular lamp taken along the line II-II in FIG. 1;

FIG. 3 is a view showing a high beam light distribution pattern formed by a high beam headlamp unit;

FIG. 4 is a view showing a low beam light distribution pattern formed by a low beam headlamp unit;

FIG. 5 is a view showing the parts mounting surface of a high beam circuit board; and

FIG. 6 is a view for describing the structure of assembling the high beam circuit board and a high beam reflector unit together.

### DETAILED DESCRIPTION OF EMBODIMENTS

Hereinafter, a description will be given in detail of a vehicular lamp according to an embodiment of the invention with reference to the drawings. Note that when terms indicating directions such as “top,” “bottom,” “front,” “rear,” “left,” “right,” “inside,” and “outside” are used in the specification, they represent directions in a position in which a vehicular lamp is mounted on a vehicle.

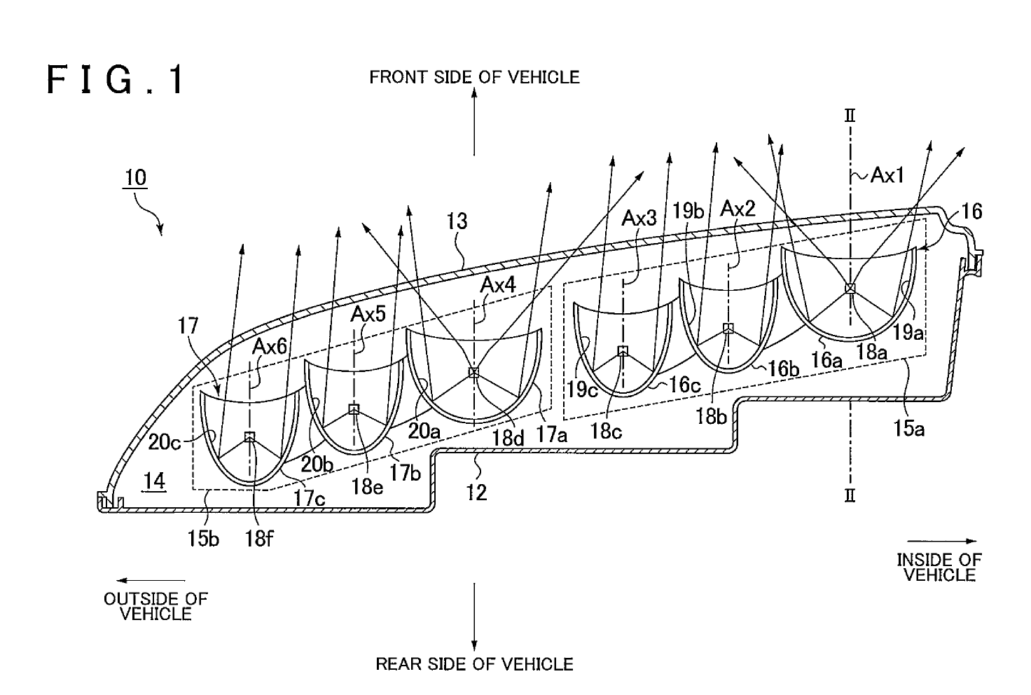

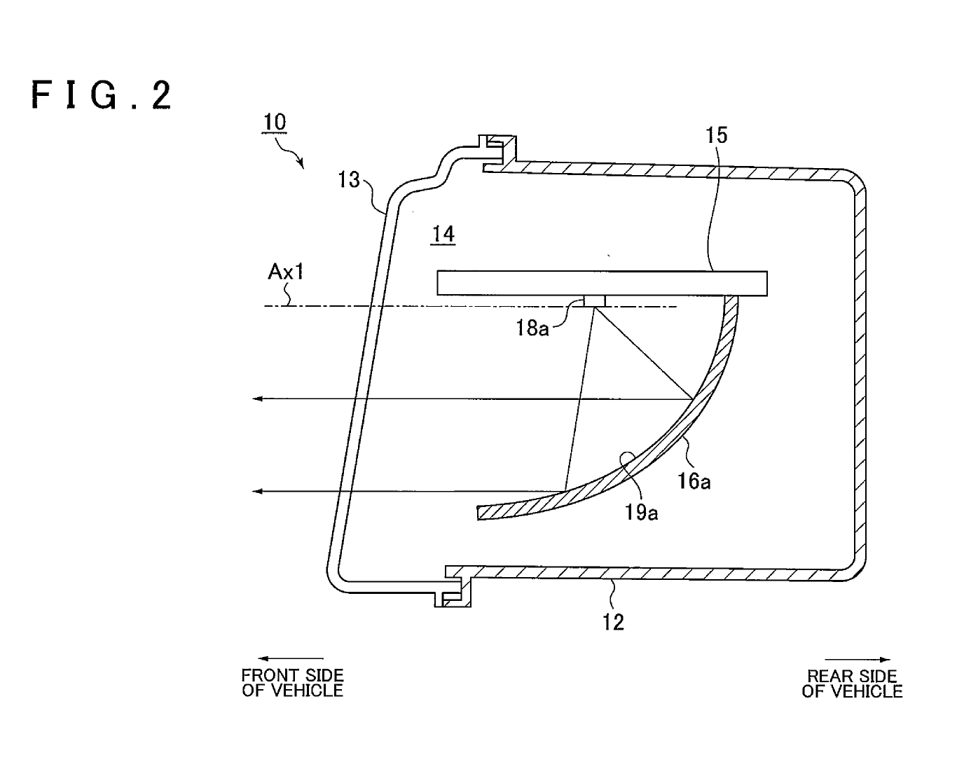

FIG. 1 is a schematic horizontal cross-sectional view of a vehicular lamp 10 according to the embodiment of the invention. In addition, FIG. 2 is a cross-sectional view of the vehicular lamp 10 taken along the line II-II in FIG. 1. Since the vehicular lamp 10 shown in FIG. 1 is a headlamp individually arranged on right and left sides at the front of the vehicle and its structure is substantially the same on the right and left sides, a description will be given of the structure of the vehicular lamp arranged on the left side of the vehicle as a representative vehicular lamp.

As shown in FIGS. 1 and 2, the vehicular lamp 10 includes a lamp body 12 and a transparent outer cover 13 that covers the front opening of the lamp body 12. The lamp body 12 and the outer cover 13 form a lamp chamber 14. As shown in FIG. 1, the outer cover 13 is formed in a shape along the slant nose shape of the vehicle and slanted rearwardly in a direction from the inside to the outside of the vehicle. The lamp body 12 is formed in a stepped shape being slanted rearwardly in the direction from the inside to the outside of the vehicle according to the shape of the slanted outer cover 13. Accordingly, the lamp chamber 14 formed by the lamp body 12 and the outer cover 13 is space slanted rearwardly in the direction from the inside to the outside of the vehicle.

The lamp chamber 14 accommodates a high beam circuit board 15a, a low beam circuit board 15b, a high beam reflector unit 16, and a low beam reflector unit 17.

The high beam circuit board 15a and the low beam circuit board 15b are arranged side by side at an upper level inside the lamp chamber 14. The high beam circuit board 15a is arranged on the inner side of the vehicle, and the low beam circuit board 15b is arranged on the outer side thereof. As shown in FIG. 1, each of the high beam circuit board 15a and the low beam circuit board 15b is formed in a shape slanted rearwardly in the direction from the inside to the outside of the vehicle according to the shape of the slanted outer cover 13.

Three LEDs (a first LED 18a to a third LED 18c) are mounted on the high beam circuit board 15a such that the light-emitting surfaces of the LEDs are directed downward. Each of the first LED 18a to the third LED 18c emits light upon receiving current from the high beam circuit board 15a. The first LED 18a to the third LED 18c are LEDs used to radiate a high beam and provided along the vehicle-width direction of the high beam circuit board 15a. Among the three LEDs, the first LED 18a is provided on the innermost side of the vehicle. The second LED 18b is provided on the outside of the first LED 18a, and the third LED 18c is provided on the outside of the second LED 18b.

Three LEDs (a fourth LED 18d to a sixth LED 18f) are mounted on the low beam circuit board 15b such that the light-emitting surfaces of the LEDs are directed downward. Each of the fourth LED 18d to the sixth LED 18f emits light upon receiving current from the low beam circuit board 15b. The fourth LED 18d to the sixth LED 18f are LEDs used to radiate a low beam and provided along the vehicle-width direction of the low beam circuit board 15b. Among the three LEDs, the fourth LED 18d is provided on the innermost side of the vehicle. The fifth LED 18e is provided on the outside of the fourth LED 18d, and the sixth LED 18f is provided on the outside of the fifth LED 18e.

The high beam reflector unit 16 and the low beam reflector unit 17 are arranged side by side beneath the high beam circuit board 15a and the low beam circuit board 15b inside the lamp chamber 14, respectively. The high beam reflector unit 16 is arranged on the inner side of the vehicle, and the low beam reflector unit 17 is arranged on the outer side thereof.

The high beam reflector unit 16 is a group of reflectors used to radiate a high beam and constituted of three parabolic reflectors, i.e., a high beam diffusion reflector 16a, a first high beam condensing reflector 16b, and a second high beam condensing reflector 16c. The three reflectors are integrally formed. Among the three reflectors, the high beam diffusion reflector 16a is provided on the innermost side of the vehicle. The first high beam condensing reflector 16b is provided on the outside of the high beam diffusion reflector 16a, and the second high beam condensing reflector 16c is provided on the outside of the first high beam condensing reflector 16b.

The high beam diffusion reflector 16a, the first high beam condensing reflector 16b, and the second high beam condensing reflector 16c, respectively, have reflection surfaces 19a to 19c formed based on the paraboloid of revolution. The revolution central axis of each paraboloid of revolution is coincident with the light axis of each of the reflectors. That is, the high beam diffusion reflector 16a has a first light axis Ax1, the first high beam condensing reflector 16b has a second light axis Ax2, and the second high beam condensing reflector 16c has a third light axis Ax3. The high beam diffusion reflector 16a, the first high beam condensing reflector 16b, and the second high beam condensing reflector 16c are arranged such that the first light axis Ax1, the second light axis Ax2, and the third light axis Ax3 are directed in the front-rear direction (horizontal direction) of the vehicle.

At the focal position (on the first light axis Ax1) of the reflection surface 19a of the high beam diffusion reflector 16a, the first LED 18a is arranged (see FIG. 2). At the focal position (on the second light axis Ax1) of the reflection surface 19b of the first high beam condensing reflector 16b, the second LED 18b is arranged. At the focal position (on the third light axis Ax3) of the second high beam condensing reflector 16c, the third LED 18c is arranged. Each of the reflectors reflects light from each of the LEDs in a direction parallel to the corresponding light axis.

The low beam reflector unit 17 is a group of reflectors used to radiate a low beam and constituted of three parabolic reflectors, i.e., a low beam diffusion reflector 17a, a first low beam condensing reflector 17b, and a second low beam condensing reflector 17c. The three reflectors are integrally formed. Among the three reflectors, the low beam diffusion reflector 17a is provided on the innermost side of the vehicle. The first low beam condensing reflector 17b is provided on the outside of the low beam diffusion reflector 17a, and the second low beam condensing reflector 17c is provided on the outside of the first low beam condensing reflector 17b.

The low beam diffusion reflector 17a, the first low beam condensing reflector 17b, and the second low beam condensing reflector 17c have reflection surfaces 20a to 20c, respectively, formed based on the paraboloid of revolution. The revolution central axis of each paraboloid of revolution is coincident with the light axis of each of the reflectors. That is, the low beam diffusion reflector 17a has a fourth light axis Ax4, the first low beam condensing reflector 17b has a fifth light axis Ax5, and the second low beam condensing reflector 17c has a sixth light axis Ax6. The low beam diffusion reflector 17a, the first low beam condensing reflector 17b, and the second low beam condensing reflector 17c are arranged such that the fourth light axis Ax4, the fifth light axis Ax5, and the sixth light axis Ax6 are directed in the front-rear direction (horizontal direction) of the vehicle.

At the focal position (on the fourth light axis Ax4) of the reflection surface 20a of the low beam diffusion reflector 17a, the fourth LED 18d is arranged. At the focal position (on the fifth light axis Ax5) of the reflection surface 20b of the first low beam condensing reflector 17b, the fifth LED 18e is arranged. At the focal position (on the sixth light axis Ax6) of the second low beam condensing reflector 17c, the sixth LED 18f is arranged. Each of the reflectors reflects light from each of the LEDs in a direction parallel to the corresponding light axis.

Each of the high beam reflector unit 16 and the low beam reflector unit 17 is formed in such a way that aluminum is deposited on the inside surface of a resin-molded base member.

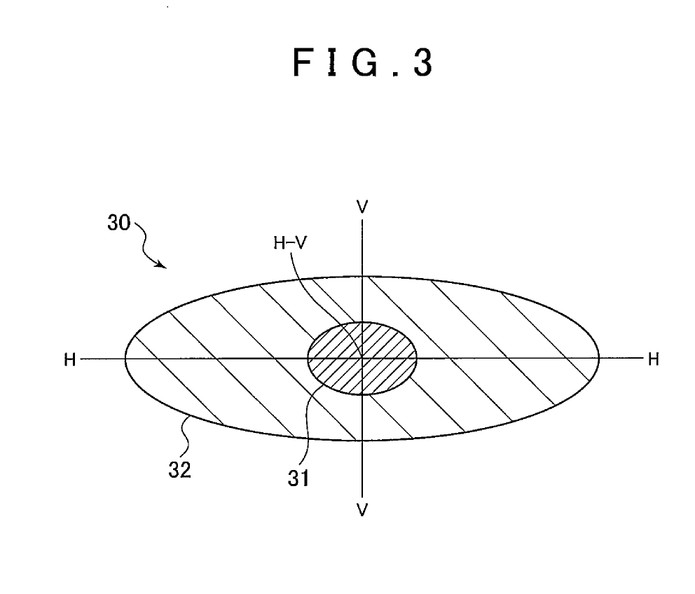

In the embodiment, the high beam reflector unit 16 and the first LED 18a to the third LED 18c constitute a high beam headlamp unit that radiates a high beam. FIG. 3 shows a high beam light distribution pattern 30 formed by the high beam headlamp unit. The high beam light distribution pattern 30 shown in FIG. 3 is a light distribution pattern formed on an imaginary vertical screen arranged at a position 25 meters ahead of the vehicular lamp 10. FIG. 3 shows a vertical line V-V passing through an H-V point as a vanishing point in the font direction of the headlamp and a horizontal line H-H passing through the H-V point.

By light reflected at the reflection surface 19b of the first high beam condensing reflector 16b after being emitted from the second LED 18b and light reflected at the reflection surface 19c of the second high beam condensing reflector 16c after being emitted from the third LED 18c, a high beam condensing light distribution pattern 31 is formed on the periphery of the H-V point. The high beam condensing light distribution pattern 31 is a high light intensity region called a “hot zone.” In addition, by light reflected at the reflection surface 19a of the high beam diffusion reflector 16a after being emitted from the first LED 18a, a high beam diffusion light distribution pattern 32 is formed so as to cover the high beam condensing light distribution pattern 31. The high beam diffusion light distribution pattern 32 is wider than the high beam condensing light distribution pattern 31 in both the direction of the horizontal line H-H and the direction of the vertical line V-V. The high beam condensing light distribution pattern 31 may be, for example, a region ranging in the direction of the horizontal line H-H by about ±10° to 15° and ranging in the direction of the vertical line V-V by about ±3° to 5°. The high beam diffusion light distribution pattern 32 may be, for example, a region ranging in the direction of the horizontal line H-H by about ±25° to 35° and ranging in the direction of the vertical line V-V by about ±8° to 10°. The high beam condensing light distribution pattern 31 and the high beam diffusion light distribution pattern 32 are superimposed on each other to form the high beam light distribution pattern 30.

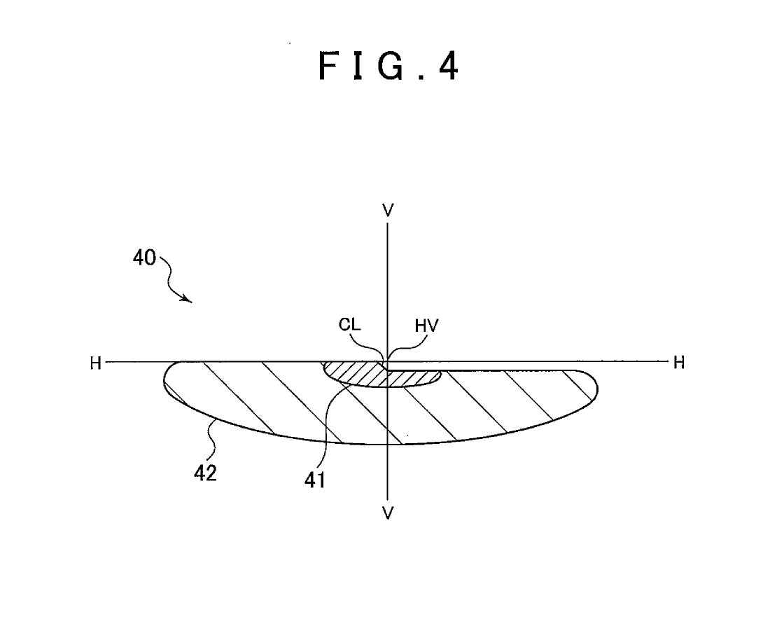

In addition, the low beam reflector unit 17 and the fourth LED 18d to the sixth LED 18f constitute a low beam headlamp unit that radiates a low beam. FIG. 4 shows a low beam light distribution pattern 40 formed by the low beam headlamp unit. The low beam light distribution pattern is a light distribution pattern having a cut-off line in a prescribed shape.

By light reflected at the reflection surface 20b of the first low beam condensing reflector 17b after being emitted from the fifth LED 18e and light reflected at the reflection surface 20c of the second low beam condensing reflector 17c after being emitted from the sixth LED 18f, a low beam condensing light distribution pattern 41 is formed on the periphery of the H-V point. The low beam condensing light distribution pattern 41 is a high light intensity region called a “hot zone” and has a cut-off line CL in a prescribed shape. In addition, by light reflected at the reflection surface 20a of the low beam diffusion reflector 17a after being emitted from the fourth LED 18d, a low beam diffusion light distribution pattern 42 is formed so as to cover the low beam condensing light distribution pattern 41. The low beam diffusion light distribution pattern 42 is wider than the low beam condensing light distribution pattern 41 in both the direction of the horizontal line H-H and the direction of the vertical line V-V. The low beam condensing light distribution pattern 41 may be, for example, a region ranging in the direction of the horizontal line H-H by about ±10° to 15° and ranging in the direction of the vertical line V-V by about 0° to −5°. The low beam diffusion light distribution pattern 42 may be, for example, a region ranging in the direction of the horizontal line H-H by about ±25° to 45° and ranging in the direction of the vertical line V-V by about 0° to −10°. The low beam condensing light distribution pattern 41 and the low beam diffusion light distribution pattern 42 are superimposed on each other to form the low beam light distribution pattern 40.

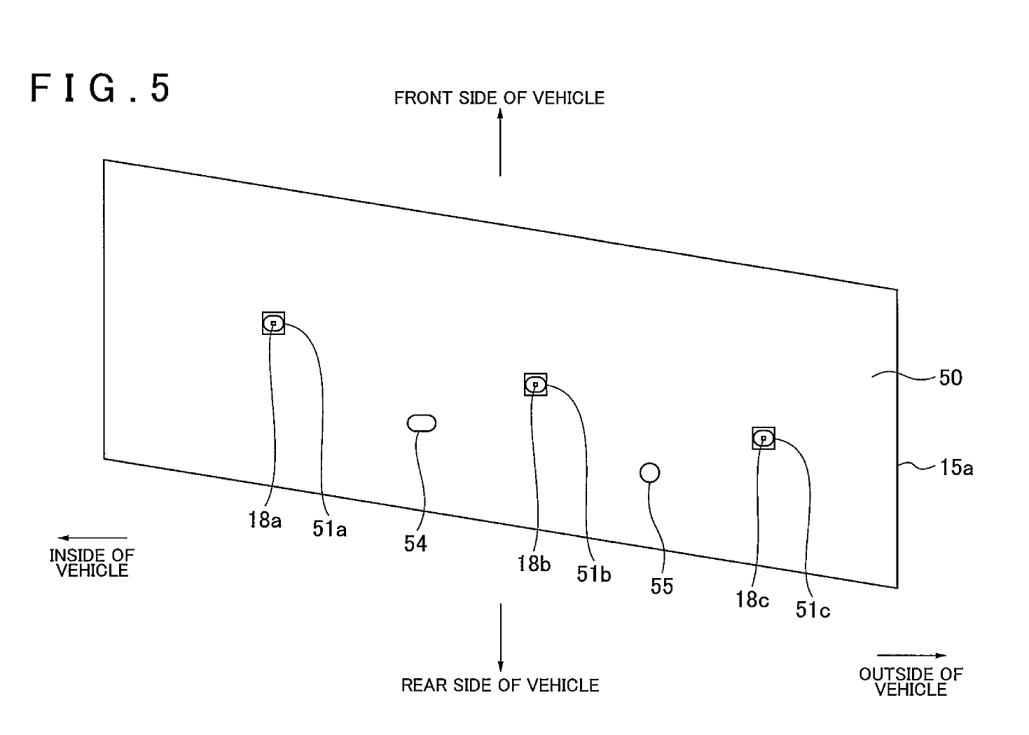

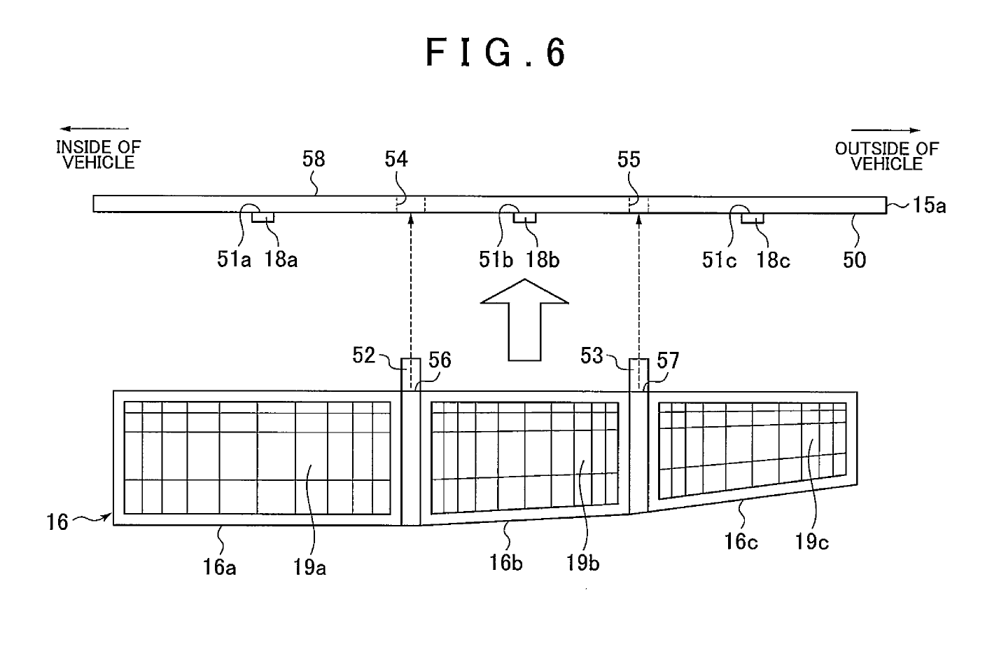

FIG. 5 is a view showing a parts mounting surface 50 of the high beam circuit board 15a. FIG. 6 is a view for describing the structure of assembling the high beam circuit board 15a and the high beam reflector unit 16 together. The parts mounting surface 50 shown in FIG. 5 is directed downward at the time of being mounted on the vehicle. FIG. 6 shows a state in which the high beam circuit board 15a and the high beam reflector unit 16 are viewed from the front side of the vehicle.

The high beam circuit board 15a has, on the parts mounting surface 50 thereof, a first LED mounting portion 51a, a second LED mounting portion 51b, and a third LED mounting portion 51c for mounting the first LED 18a, the second LED 18b, and the third LED 18c, respectively, along the vehicle-width direction of the circuit board. Each of the LED mounting portions may be an electrode land for soldering the electrode of each of the LEDs. The high beam circuit board 15a has a copper foil pattern (not shown) for supplying current to each of the electrode lands.

As shown in FIG. 6, the high beam reflector unit 16 is mounted on the parts mounting surface 50 of the high beam circuit board 15a. In the embodiment, the high beam reflector unit 16 has a first positioning pin 52 and a second positioning pin 53. In addition, the high beam circuit board 15a has a first positioning hole 54 which is provided at a position corresponding to the first positioning pin 52 to receive the first positioning pin 52 and has a second positioning hole 55 which is provided at a position corresponding to the second positioning pin 53 to receive the second positioning pin 53. When the positioning pins 52 and 53 are arranged in the positioning holes 54 and 55, respectively, the high beam reflector unit 16 is positioned on the parts mounting surface 50 of the high beam circuit board 15a.

The first positioning pin 52 protrudes from a first joining portion 56 that joins the high beam diffusion reflector 16a and the first high beam condensing reflector 16b together. The second positioning pin 53 protrudes from a second joining portion 57 that joins the first high beam condensing reflector 16b and the second high beam condensing reflector 16c together. Each of the first positioning pin 52 and the second positioning pin 53 may be a cylindrical pin. The first positioning pin 52 and the second positioning pin 53 may be the same in size. Each of the first positioning pin 52 and the second positioning pin 53 may be formed to have a height corresponding to the thickness of the high beam circuit board 15a or more.

As shown in FIG. 5 and FIG. 6, the first positioning hole 54 is provided in the circuit board at a location inward of the first LED mounting portion 51a positioned on one end side (the inner side of the vehicle) in the vehicle-width direction of the high beam circuit board 15a, and the second positioning hole 55 is provided in the circuit board at a location inward of the third LED mounting portion 51c positioned on the other end side (the outer side of the vehicle) in the vehicle-width direction thereof. More specifically, the first positioning hole 54 is provided between the first LED mounting portion 51a and the second LED mounting portion 51b adjacent to the first LED mounting portion 51a, and the second positioning hole 55 is provided between the third LED mounting portion 51c and the second LED mounting portion 51b adjacent to the third LED mounting portion 51c.

In the embodiment, the first positioning hole 54 is a long hole extending in the vehicle-width direction of the circuit board. In a case in which the first positioning pin 52 to be inserted in the first positioning hole 54 has a cylindrical shape, the first positioning hole 54 is a long hole having the inside diameter thereof greater than the diameter of the first positioning pin 52 in the vehicle-width direction and having the inside diameter thereof substantially the same in size as the diameter of the first positioning pin 52 in the front-rear direction of the vehicle in a cross section perpendicular to the height direction of the circuit board. On the other hand, in the cross section perpendicular to the height direction of the circuit board, the second positioning hole 55 is a hole having the substantially same shape and size as the second positioning pin 53 to be inserted in the second positioning hole 55. In a case in which the second positioning pin 53 has a cylindrical shape, the second positioning hole 55 is a cylindrical hole having the inside diameter thereof same as the diameter of the second positioning pin 53.

When the high beam reflector unit 16 is assembled into the high beam circuit board 15a, the first positioning pin 52 and the second positioning pin 53 of the high beam reflector unit 16 are inserted in the first positioning hole 54 and the second positioning hole 55 of the high beam circuit board 15a, respectively, as shown in FIG. 6. Then, portions of the first positioning pin 52 and the second positioning pin 53 protruding to the side of the back surface 58 opposing the parts mounting surface 50 are subjected to thermal caulking to fix the high beam reflector unit 16 to the high beam circuit board 15a. Note that in the embodiment, the first positioning pin 52 and the second positioning pin 53 serve to position and fix the high beam reflector unit 16 to the high beam circuit board 15a. However, it may also be possible to use the first positioning pin 52 and the second positioning pin 53 only to position the high beam reflector unit 16 and perform the fixation of the high beam reflector unit 16 to the high beam circuit board 15a using other members. For example, it may also be possible to form holes in the high beam circuit board 15a and the high beam reflector unit 16 for screw fixation and fix the high beam reflector unit 16 to the high beam circuit board 15a using screws.

As for a vehicular lamp using a plurality of LEDs and a plurality of reflectors as in the embodiment, it is likely that the headlamp is upsized with an increase in the size of a circuit board since the plurality of LEDs and the plurality of reflectors are arranged. Accordingly, in the embodiment, the first positioning hole 54 is provided in the circuit board at a location inward of the first LED mounting portion 51a positioned on one end side in the vehicle-width direction of the high beam circuit board 15a, and the second positioning hole 55 is provided in the circuit board at a location inward of the third LED mounting portion 51c positioned on the other end side in the vehicle-width direction thereof. Thus, compared with a case in which the first positioning hole is provided in the circuit board at a location outward of the first LED mounting portion of the circuit board and the second positioning hole is provided in the circuit board at location outward of the third LED mounting portion, the length of the circuit board in the vehicle-width direction may be made shorter. Therefore, the vehicular lamp that is small in size although it has the plurality of LEDs and the plurality of reflectors can be achieved.

In addition, in the above embodiment, the first positioning hole 54 is the long hole extending in the vehicle-width direction of the circuit board, while the second positioning hole 55 is the hole having the substantially same shape and size as the second positioning pin 53 to be inserted in the second positioning hole 55. Since the high beam reflector unit 16 is a resin-molded item, it has a greater size tolerance than the parts mounting surface 50. One of the two positioning holes formed in the long hole as in the embodiment allows the size tolerance of the high beam reflector unit 16.

Moreover, in the above embodiment, the second positioning hole 55 formed to be substantially the same in shape and size as the second positioning pin 53 is, as shown in FIG. 5 and FIG. 6, provided at a position closer to the second LED mounting portion 51b and the third LED mounting portion 51c where the second LED 18b and the third LED 18c for condensing are mounted, respectively, than the first LED mounting portion 51a where the first LED 18a for diffusion is mounted. This is because the second LED 18b and the third LED 18c for condensing require higher positioning accuracy than the first LED 18a for diffusion. With such a configuration, the light distribution performance of the vehicular lamp 10 can be improved.

The above description is mainly applied to the structure of assembling the high beam circuit board 15a and the high beam reflector unit 16 together but may also be applied to the structure of assembling the low beam circuit board 15b and the low beam reflector unit 17 together.

The above embodiment describes that the three LEDs and the three reflectors are each provided in the high beam reflector unit 16 and the low beam reflector unit 17, but four or more LEDs and four or more reflectors may be each provided therein.

The invention is described above based on the embodiment. However, the embodiment is only for illustrative purposes, and various modifications to the combinations of the respective constituents and embodiments including such modifications are also within the scope of the invention.

The above embodiment describes the LEDs as light sources, but the light sources are not limited to the LEDs. For example, semiconductor lasers, bulbs, or the like may be used as such.

What is claimed is:

1. A vehicular lamp comprising:
a circuit board having three or more light source mounting portions provided along a vehicle-width direction;
a plurality of light sources mounted on the respective light source mounting portions; and
a reflector unit having three or more reflectors each reflecting light from each of the light sources, wherein:
the reflector unit has a first positioning pin and a second positioning pin;
the circuit board has a first positioning hole to receive the first positioning pin and a second positioning hole to receive the second positioning pin;
the first positioning hole is provided at a location inward of a first end light source mounting portion positioned on one end side of the circuit board in the vehicle-width direction, among the light source mounting portions; and
the second positioning hole is provided at a position inward of a second end light source mounting portion positioned on the other end side of the circuit board in the vehicle-width direction, among the light source mounting portion.

2. The vehicular lamp according to claim 1, wherein:
the first positioning hole is provided between the first end light source mounting portion and one of the light source mounting portions adjacent to the first end light source mounting portion; and
the second positioning hole is provided between the second end light source mounting portion and one of the light source mounting portions adjacent to the second light source mounting portion.

3. The vehicular lamp according to claim 1, wherein:
the first positioning hole is a long hole extending in the vehicle-width direction of the circuit board; and
the second positioning hole has a substantially same shape and size as the second positioning pin.
